(19) United States
(12) Patent Application Publication
(10) Pub. No.: US 2022/0203887 A1
(43) Pub. Date: Jun. 30, 2022

(54) DEVICE AND METHOD FOR WARNING A FOLLOWING VEHICLE THAT IS NOT KEEPING A SAFETY DISTANCE

(71) Applicant: BAUCHER ETUDES & CONSEILS, La Celle Saint Cloud (FR)

(72) Inventor: Philippe BAUCHER, La Celle Saint Cloud (FR)

(21) Appl. No.: 17/600,378

(22) PCT Filed: Mar. 17, 2020
(86) PCT No.: PCT/FR2020/050573

§ 371 Date: Sep. 30, 2021

(30) Foreign Application Priority Data
Apr. 30, 2019 (FR) 1904543

(51) Int. Cl. B60Q 1/50; B60Q 1/30; G08G 1/017; G08G 1/0962; H04W 4/48

(52) U.S. Cl. CPC B60Q 1/503; B60Q 1/302; H04W 4/48; G08G 1/09626; G08G 1/0175

(57) ABSTRACT

Disclosed is a warning system to be provided on a first vehicle, which includes a radar for measuring the distance D with a second vehicle that is following same, a display visible from the following vehicle, a unit for calculating the safety distance DS and a camera for reading the registration number of the second vehicle.

### BACKGROUND OF THE INVENTION

### Field of the Invention

The present invention relates to the field of road safety. More particularly, the present invention relates to a device for assistance in keeping the safety distances to be maintained between two vehicles that are following one another.

It is observed that 43% of the accidents on the motorway result from collisions at the rear which can be chain collisions. Among these accidents, about 15% of the accidents with bodily injury are collisions at the rear or in chain, causing the death of nearly 300 people per year.

Keeping a safety distance between two vehicles that are following one another is therefore a necessity. The safety distance is the distance travelled during the time that the driver of a vehicle needs to react when they perceive an event occurring on their path, increased by the braking distance, i.e. the distance that the vehicle needs to stop starting from the moment when the driver actuates the brake.

As a first approximation, the safety distance is the distance travelled by the vehicle in 2 seconds, which:
at 50 km/h, is 30 m;
at 90 km/h, is 50 metres;
at 110 km/h, is 70 metres; and,
at 130 km/h, is 80 metres.

In France, the “Prévention Routière” (Road Safety) association gives even more cautious recommendations. Furthermore, these distances, calculated for a dry ground, are to be substantially increased on wet ground.

### Description of the Related Art

There are driver assistance systems, proposed on recent models of vehicles, that make it possible to warn the driver that they are too close to the vehicle in front of them. This assistance—which is on the path for promoting autonomous vehicles—undeniably provides additional safety. However, this assistance can generally be deactivated by the driver, if they do not want to have this safeguard imposed on them; even if it is not deactivated, the driver remains free to take it into account, or not. In addition, the rate of the automobile fleet equipped with such assistance is still low and it will still take many years before this equipment is generalised.

Law enforcement agencies are considering using drones that monitor the traffic, but this solution will probably be expensive, repressive only and cannot be global. It will be insufficient in fully ensuring the safety of the many drivers who are subjected to the aggressivity of other drivers who tailgate the rear of their vehicle and who exert pressure on them to leave them passage.

### SUMMARY OF THE INVENTION

The purpose of the invention is to propose a warning system that cannot be deactivated by the following driver, aggressive or distracted, who would not keep a sufficient distance with a followed vehicle, and which encourages them to comply with the warning received.

To solve this problem the invention proposes a warning system, for equipping a first vehicle, that comprises:
a device for measuring, where applicable, a clear distance at the rear of the first vehicle, between a second vehicle that is following same, called the following vehicle, and the first vehicle, called warning vehicle;
a display disposed at the rear of the first vehicle, in such a way that it is visible from the following vehicle, where applicable;
means for calculating a safety distance according, in particular to the speed of the first vehicle, and, preferably, according to the external conditions of the first vehicle.

The external conditions can be the condition of the road surface, moisture of the road surface, rain, wind or fog.

The invention also relates to a warning method that uses a system according to the invention.

### BRIEF DESCRIPTION OF THE DRAWINGS

Several embodiments of the invention will be described hereinafter, by way of non-limiting examples, in reference to the accompanying drawings wherein:

FIG. 1 is a perspective view, of a car provided with a system according to the invention, followed by another;

FIG. 2 is a schematic view showing the operation of the system of FIG. 1;

FIG. 3 is a flowchart showing the operation of the system of FIG. 1;

FIG. 4 shows a first possible display for the system of FIG. 1;

FIG. 5 shows a second possible display for the system of FIG. 1;

FIG. 6 shows a third possible display for the system of FIG. 1; and,

FIG. 7 shows a fourth possible display for the system of FIG. 1.

### DESCRIPTION OF THE PREFERRED EMBODIMENTS

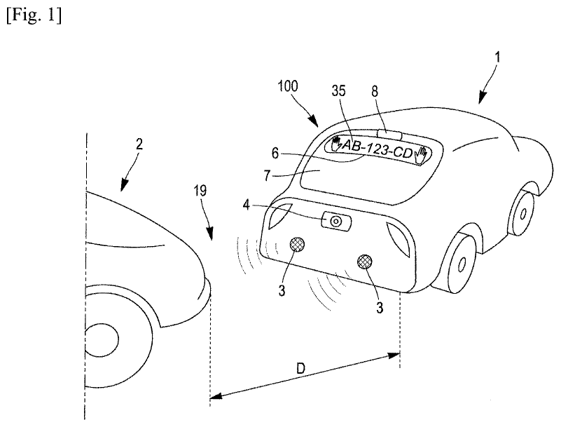

FIG. 1 shows a first vehicle 1 followed by a second vehicle 2. In what follows, the first vehicle is called “warning vehicle” and the second is called “following vehicle”. A distance D separates the two vehicles. The first vehicle is called warning vehicle, since it is provided with a system 100 that allows it to monitor a zone 19 at its rear, to monitor the keeping of a safety distance DS between it and the following vehicle, i.e. the distance D that separates the two vehicles is greater than or equal to the distance DS, and, to warn the following vehicle when the distance DS is not kept.

The system 100 comprises several pieces of equipment shown in FIG. 1:
rear radars 3;
a rear camera 4;
a display 6, that can be seen by a driver of the following vehicle 2 through the rear windscreen 7 of the warning vehicle 1; and,
a “brake” light 8 disposed at the top of the rear windscreen 7.

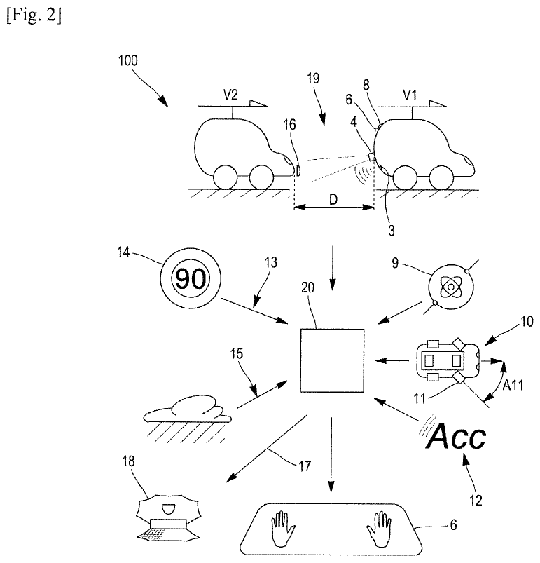

The system 100 is shown in more detail in FIG. 2. It comprises other equipment which is shown therein:
a gyroscope 9;
means for acquiring 10 an instantaneous steering angle All of the steered wheels, here the front wheels;
an accelerometer 12;
means of acquisition 13 for a local limitation 14 of the speed;
means of acquisition 15 for meteorological data 16; and,
means of communication 17 with law enforcement agencies.

The processing means are advantageously provided to acquire data supplied by the controller (ECU, acronym for “Electronic Control Unit”) on board the warning vehicle. This data can in particular comprise:
the speed V1 of the warning vehicle;
certain meteorological data 16, for example the presence of rain or fog;
data from the rear camera;
data from the rear radar;
the steering angle A11; or,
data concerning the crossing of a line, where applicable.

The system 100 further comprises computer processing means 20. These processing means can be those of a telephone of the smartphone type, associated with a specific application.

The means of global geographical positioning can be those of the vehicle, if it has them, or those of the telephone. These positioning means can for example use the satellites of the European system Galileo. The positioning means are used in particular as means of acquisition 13 for the local speed limitation 14.

Where applicable, the communication between the controller and the telephone can be established according to a short-distance communication protocol, preferably of the Bluetooth® type.

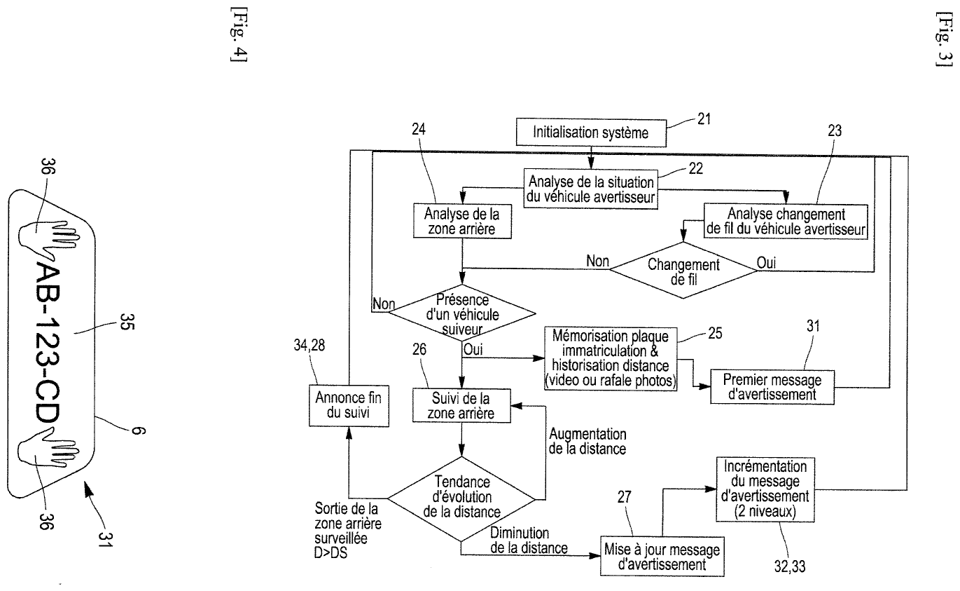

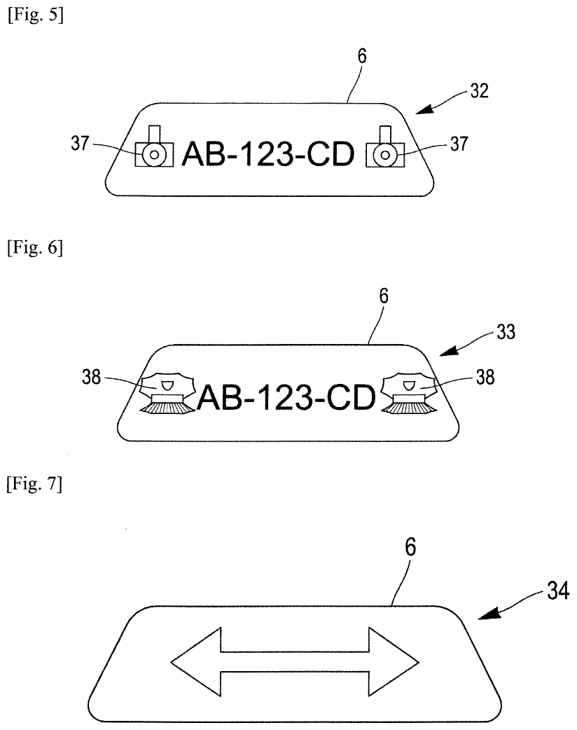

From the data collected, several service modules are implemented by the system according to the invention:
Recovery of the speed of the equipped vehicle, the warning vehicle;
Analysis of the changes in direction of the equipped vehicle;
Recovery of the dis(continuous) line crossing alerts;
Monitoring of changes in direction (gyroscope);
Calculation of the safety distance;
Detection of the presence of a following vehicle;
Recovery of the angle of the wheels of the equipped vehicle;
Analysis of the attitude of the following vehicle (moving away or moving closer);
Identification of the plate of the following vehicle (photo);
Memorising of the plate and the start of recording;
Sending the collected data to the server;
Display of the first warning level (see FIGS. 1 and 4);
Display of the second warning level (see FIG. 5);
Display of the third warning level (see FIG. 6);
Display of the return to normal (see FIG. 7).

To determine the safety distance DS, the warning system determines the speed V2 of the following vehicle from the speed V1 of the warning vehicle and the closing speed of the following vehicle. The closing speed is calculated from successive measurements of the distance D between the two vehicles. As a first approximation, the safety distance can be calculated from only the speed V1 of the warning vehicle.

The safety distance DS can be modulated, in particular according to the meteorological data 15.

An operation for the device according to the invention shall now be described in reference to the diagram of FIG. 3.

When the system 100 is operating, i.e. after the initialisation 21 thereof, generally when the warning vehicle 1 is started up, the system initiates a recurring analysis 22, i.e. a monitoring, of the situation of the warning vehicle 1.

The analyse of the situation first consists of conducting, in parallel, an analysis 23 of a lane change and an analysis 24 of a safety zone 19, at the rear of the warning vehicle 1.

The analysis of the lane change makes it possible to check whether or not the vehicle is stabilised on a traffic lane. To carry out this analysis 23, the system 100 uses data relative to the angle A11 of the wheels, at the crossing of a continuous or discontinuous line, coming from the gyroscope 9.

As long as the warning vehicle 1 is not stabilised in a traffic lane, the system 100 conducts no other analysis, as the analysis of the safety zone 19 is not significant.

As soon as the warning vehicle is considered to be stabilised in a traffic lane, the system checks if the analysis of the safety zone 19 has made it possible to detect the presence of a following vehicle and if this vehicle is at a distance D less than the calculated safety distance DS. If this is not the case, the system 100 continues the analysis 24 of the rear zone and the analysis 23 of the lane change.

If a following vehicle 2 is detected at a distance D less than the safety distance DS, the system identifies 25 the following vehicle and displays on the display 26 a first warning message 31.

The identification 25 of the following vehicle 2 comprises a recording of the plate registration number 16. This recording is done using a camera 4, as a photo or a video; this identification phase further comprises a memorisation of a history of the distances D, as long as this following vehicle remains in the safety zone 19 or at a distance D less than the safety distance DS.

The identification phase also checks, during the monitoring and at each new recording in the history of the distances D, that:
the following vehicle is still the same;
if the following vehicle has just positioned itself behind the warning vehicle; or,
if the warning vehicle has just positioned itself in front of the following vehicle.

When it is the warning vehicle that has just positioned itself in front of the following vehicle, without leaving a sufficient safety distance, a reminder can be triggered in the warning vehicle, for example an audible beep and/or an indication on the dashboard of the warning vehicle 1.

In the example shown, the first warning message 31 represents the registration number 35 of the following vehicle 2 associated with two blinking icons 36 of orange colour. Each icon 36 represents a palm turned towards the rear, encouraging the driver of the following vehicle 2 to leave more distance.

The monitoring continues and the system 100 analyses the change in the distance D.

If the distance D decreases, the system 100 displays on the display 26 a second warning message 32. In the example shown, the second warning message 32 represents the registration number 35 of the following vehicle 2 associated with two blinking icons 37 of orange colour. Each icon 37 represents a camera turned towards the rear, informing the driver of the following vehicle that their registration has been read.

If the distance D decreases further, the system 100 displays on the display 26 a third warning message 33. In the example shown, the third warning message 32 represents the registration number 35 of the following vehicle 2 associated with two blinking icons 38 of red colour. Each icon represents a police officer's cap, informing the driver of the following vehicle that their registration has been transmitted to the law enforcement agencies. Preferably, the transmission comprises the history of the distances, the time-stamping thereof and the geographical coordinates thereof.

More generally, the identity of the following vehicle 2 is transmitted to a remote computer server, accessible to law enforcement agencies and/or hosted by law enforcement agencies. Thus, the processing of the information transmitted, materialising infractions, in particular a video, a photo or several photos taken in burst mode, can be carried out by sending to a server that centralises all the data collected. This sending can be carried out via a long-range exchange protocol of the GSM type by the application present on the smartphone or by a communication component integrated into the electronics of the vehicle. This information can:
be used as a support to file a complaint against an aggressive driver having committed a characterised infraction; and/or,
be used by the insurance of the warning vehicle in the case where the non-keeping of the safety distance is a cause of an accident wherein the responsibility of the driver of the following vehicle can be engaged.

If the distance D increases beyond the distance DS, the system 100 displays a fourth message 34, meaning that the safety distance DS is kept. In the example shown, this fourth message represents a green double arrow.

Of course, thresholds are advantageously set, for the decrease as well as the increase in the distance D, beyond which no display change is carried out.

Of course, the invention is not limited to the examples that have just been described. On the contrary, the invention is defined by the claims that follow.

It will indeed appear to those skilled in the art that various modifications can be made to the embodiments described hereinabove, in light of the teaching that has just been disclosed to them.

Thus, many elements and functions can supplement a system according to the invention. In particular, the system can comprise means of displaying on the dashboard.

A warning system according to the invention, affixed to the rear windscreen of a warning vehicle, makes it possible to dissuade an aggressive driver from abusively reducing the distance that separates them from the vehicle thus equipped.

In the same way that a brake light on the “followed” vehicle warns the “following” vehicle of braking, this same “followed” vehicle can warn the “following” vehicle that they are committing an infraction and that they are taking the risk of a complaint that can result in a fine such as described in the introduction.

Such a warning capacity can also be affixed on an autonomous vehicle. Indeed, the behaviour of an autonomous vehicle can surprise a following driver with aggressive driving; an additional margin of safety must therefore be provided.

Preferably, a system according to the invention is provided as standard or as an option on a new vehicle.

The system can also be a piece of equipment independent of the vehicle provided to be installed afterwards, for example on a second-hand vehicle. The system can then comprise a refined case that integrates a camera and radar.

Contrary to what was shown hereinabove, a vehicle may not comprise a third brake light independent of the display of the system. The display can be a substitute for this third brake light; it then forms an extension of it.

Also, the display can comprise a projector that projects the display onto the rear windscreen, according to principles similar to those of “head up” displays.

The display can be of variable intensity. For example, the size of the display can increase when the distance decreases; also, the light intensity can increase when the distance decreases.

1. Warning system, to be provided on a first vehicle, which comprises:
a device for measuring, where applicable, a clear distance at the rear of said first vehicle, between a second vehicle that is following same;
a display disposed at the rear of said first vehicle, in such a way that the display is visible from the following vehicle, where applicable; and,
means for calculating a safety distance DS according, to the speed of said first vehicle.

2. The system according to claim 1, further comprising a device for recording an identity of the following vehicle.

3. The system according to claim 2, further comprising a device for transmitting the identity of the following vehicle to a remote server.

4. The system according to claim 1, further comprising means for characterising a lane change.

5. The system according to claim 4, wherein the means for characterising a lane change comprise means from among a gyroscope, means for acquiring a steering angle of a steered wheel and an accelerometer.

6. The system according claim 1, further comprising processing means adapted for communicating, with an on-board controller of the first vehicle.

7. Method for warning of the non-keeping of a safety distance, wherein the method uses a system according to claim 1, provided on a first vehicle.

8. The method according to claim 7, comprising:
determining a safety distance, according to the speed of the first vehicle;
monitoring a safety zone at the rear of said first vehicle;
if a second vehicle penetrates said safety zone at a distance less than said safety distance, displaying on the display a warning message.

9. A method for warning that a vehicle is not keeping a safe distance, comprising:
using the warning system of claim 1, determining a safety distance, according to the speed of the first vehicle;
monitoring a safety zone at the rear of said first vehicle; and
if a second vehicle penetrates said safety zone at a distance less than said safety distance, displaying a warning message on the display.

10. The warning system of claim 1, wherein the calculation performed by the means for calculating a safety distance also considers external conditions.

11. The system of claim 2, wherein the display displays the identity of the following vehicle.

12. The system according to claim 2, further comprising means for characterising a lane change.

13. The system according to claim 3, further comprising means for characterising a lane change.

14. The system of claim 6, wherein the processing means communicates with the on-board controller using a short distance protocol.

15. The system according to claim 2, further comprising processing means adapted for communicating with an on-board controller of the first vehicle.

16. The system according to claim 3, further comprising processing means adapted for communicating with an on-board controller of the first vehicle.

17. The system according to claim 4, further comprising processing means adapted for communicating with an on-board controller of the first vehicle.

18. The system according to claim 5, further comprising processing means adapted for communicating with an on-board controller of the first vehicle.

19. The system according to claim 11, further comprising processing means adapted for communicating with an on-board controller of the first vehicle.

20. The system according to claim 12, further comprising processing means adapted for communicating with an on-board controller of the first vehicle.
